(19) United States
(12) Patent Application Publication
(10) Pub. No.: US 2014/0379767 A1
(43) Pub. Date: Dec. 25, 2014

(54) OUT OF BAND METHODS AND SYSTEM OF ACQUIRING ACCESS DATA IN A PARALLEL ACCESS NETWORK FILE SYSTEM AND METHODS OF USING SUCH ACCESS DATA

(71) Applicant: Tonian Inc., Natania (IL)

(72) Inventors: Ben Zion HALEVY, Tel-Aviv (IL); Amit GOLANDER, Tel-Aviv (IL)

(21) Appl. No.: 13/925,889

(22) Filed: Jun. 25, 2013

(51) Int. Cl. G06F 17/30

(52) U.S. Cl. CPC G06F 17/30224
USPC 707/827

(57) ABSTRACT

A method for gathering access data of a file stored in one or more storage devices of a parallel access network file system. The method comprises monitoring layout requests received from a plurality of clients of the parallel access network file system, each the layout request is for a layout of data segments of one of a plurality of data objects which are stored in a plurality of storage devices of a parallel access network file system, sending to the plurality of clients a plurality of recall requests to recall a plurality of layouts requested by the plurality of layout requests, monitoring a plurality of recurring layout requests for mapping data segments of at least some of the plurality of data objects from at least some of the plurality of clients, and updating access data of the plurality of data objects according to the plurality of recurring layout requests.

### RELATED APPLICATION

This application claims the benefit of priority under 35 USC §119(e) of U.S. Provisional Patent Application No. 61/665,333 filed Jun. 28, 2012 the contents of which are incorporated herein by reference in their entirety.

### BACKGROUND

The present invention, in some embodiments thereof, relates to access data and, more particularly, but not exclusively, to methods and system of out of band access data acquisition.

During the last years, the storage input and/or output (I/O) bandwidth requirements of clients have been rapidly outstripping the ability of network file servers to supply them. This problem is being encountered in installations running according to network file system (NFS) protocol. In order to overcome this problem, parallel NFS (pNFS) has been developed. pNFS allows clients to access storage devices directly and in parallel. The pNFS architecture increases scalability and performance compared to former NFS architectures. This increment is achieved by the separation of data and metadata and using a metadata server out of the data path.

In use, a pNFS client initiates data control requests on the metadata server, and subsequently and simultaneously invokes multiple data access requests on the cluster of data servers. Unlike in a conventional NFS environment, in which the data control requests and the data access requests are handled by a single NFS storage server, the pNFS configuration supports as many data servers as necessary to serve client requests. Thus, the pNFS configuration can be used to greatly enhance the scalability of a conventional NFS storage system. The protocol specifications for the pNFS can be found at itef.org, see NFS4.1 standards and Requests for Comments (RFC) 5661-5664 which include features retained from the base protocol and protocol extensions. Major extensions such as sessions, and directory delegations, external data representation standard (XDR) description, a specification of a block based layout type definition to be used with the NFSv4.1 protocol, and an object based layout type definition to be used with the NFSv4.1 protocol.

### SUMMARY

According to some embodiments of the present invention, there is provided a computerized method for gathering access data of a file stored in one or more storage devices of a parallel access network file system. The method comprises monitoring a plurality of layout requests received from a plurality of clients of the parallel access network file system, each the layout request is for a layout of data segments of one of a plurality of data objects which are stored in a plurality of storage devices of a parallel access network file system, sending to the plurality of clients a plurality of recall requests to recall a plurality of layouts requested by the plurality of layout requests, monitoring a plurality of recurring layout requests for mapping data segments of at least some of the plurality of data objects from at least some of the plurality of clients, and updating access data of the plurality of data objects according to the plurality of recurring layout requests.

Optionally, each the recall request is iteratively sent for reclaiming a respective the layout in a dynamic rate that is set for the respective layout.

More optionally, the dynamic rate is set according to a tier of at least one of a storage device which hosts data segments mapped by the layout and an access data ranking of data segments mapped by the layout.

Optionally, the computerized method further comprises updating the access data to indicate which of the plurality of layout requests is sent for a write operation and accordingly.

More optionally, the updating comprises detecting a message indicative of a writing operation that is performed by a respective the client.

More optionally, the updating comprises measuring a time period between the sending of each the recall request and a detection of a message indicative of the release of a respective layout.

More optionally, the computerized method further comprises time tagging each the layout request; wherein the sending comprises timing the sending of each the recall request according to a time tag of a respective the layout request.

More optionally, the computerized method further comprises ranking the plurality of data objects; wherein the timing comprises timing the sending of each the recall request according to the rank of a respective data object which is mapped by the respective the layout request.

Optionally, the sending is performed iteratively every predefined period.

More optionally, the plurality of layout requests and the plurality of recurring layout requests are LAYOUTGET requests.

Optionally, the parallel access network file system is a parallel network file system (pNFS).

Optionally, the monitoring is performed during an operation period of the parallel access network file system; further comprising reallocating data segments of at least some of the plurality of data objects according to the access data during the operation period.

More optionally, the plurality of storage devices are tiered to a plurality of tiers, further comprising performing the reallocating according to the access data to correlate between access frequency of the data segments and the tier of a respective the storage device.

Optionally, the plurality of data objects comprise a plurality of subfiles of a plurality of files.

More optionally, the computerized method further comprises setting an access rate indicator to each the subfile; wherein each the recall request is iteratively sent for reclaiming a respective the layout in a rate that is adaptively determined based on a respective the access rate indicator.

Optionally, the computerized method further comprises dividing the plurality of files to the plurality of subfiles; wherein the size of at least some of the plurality of subfiles is set according to a respective access rate indicator.

Optionally, the computerized method further comprises measuring a time period between the sending of each the recall request and a detection of a respective recurring layout request from the plurality of recurring layout requests and estimating a write related input/output (I/O) intensiveness of a respective the client.

Optionally, the computerized method further comprises analyzing an OFFSET field in at least some of the plurality of recurring layout requests and the plurality of layout requests to identify in a sequential access to the last section of at least one of the plurality of data segment, and reallocating the at least one segment in response to the identification.

Optionally, the computerized method further comprises analyzing at least some of the plurality of recurring layout requests and the plurality of layout requests to identify in a sequence of write append access to the last section of at least one of the plurality of data segment, and reallocating the at least one data segment in response to the identification.

Optionally, the computerized method further comprises acquiring MINLENGTH values of at least some of the plurality of recurring layout requests and updating the access data accordingly.

According to some embodiments of the present invention, there is provided a metadata server of a parallel access network file system. The metadata server comprises a processor, a database, a monitoring module which monitors a plurality of layout requests each for mapping data segments of one of a plurality of data objects which are stored in a plurality of storage devices of a parallel access network file system, the plurality of layout requests being received from a plurality of clients of the parallel access network file system, an access data logger which updates access data stored in the database according to the plurality of layout requests, and a recall module which sends a plurality of recall requests to the plurality of clients according to the plurality of layout requests. The monitoring module monitors a plurality of recurring layout requests for mapping data segments of at least some of the plurality of data objects from at least some of the plurality of clients. The access data logger updates the access data according to the plurality of recurring layout requests.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a storage system that includes metadata server (MDS) and a plurality of storage devices (also known in pNFS as data servers) which provide storage services to a plurality of concurrent retrieval clients, according to some embodiments of the present invention;

FIG. 2 is a flowchart of a method for gathering access data of files stored in storage devices of a parallel access network file system, such as the system depicted in FIG. 1, according to some embodiments of the present invention;

FIG. 3 is a schematic illustration of a state machine wherein states reflect actions and transition arrows relate to external triggers which are performed with regard to a certain layout, according to some embodiments of the present invention;

FIGS. 4A and 4B depict schematic illustrations of state machines which are similar to the state machine in FIG. 3; however, in these state machine a write counter is updated when a write operation is detected, according to some embodiments of the present invention;

FIG. 5 is a schematic illustration of a state machine, which is similar to the state machine of FIG. 3; however in this state machine a write counter is updated for each file chuck, according to some embodiments of the present invention; and

FIG. 6 is a schematic illustration of a state machine having an adaptive reclaiming rate and/or adaptive subfiles size, according to some embodiments of the present invention.

### DETAILED DESCRIPTION

The present invention, in some embodiments thereof, relates to access data and, more particularly, but not exclusively, to methods and system of out of band access data acquisition.

According to some embodiments of the present invention, there are provided out of band methods and systems for acquiring up-to-date data indicative of access (i.e. write/read operations) to data segments in a network file system by periodically reclaiming pending layout requests and monitoring the response to the periodic reclaiming. In such embodiments, empiric data which is indicative of blocks actual usage is acquired. Optionally, the acquired data allows automatically and adaptively reallocating blocks to different storage devices with different tier levels according to statistical analysis of current usage patterns.

Optionally, the data is acquired by the metadata server of the storage system, such has a pNFS system, and not by modules which are installed in the clients and/or the storage devices. This allows avoiding drawbacks such as using components which are not part of the pNFS standard, installing a plurality of software components in all clients and/or storage devices, and/or gathering incoherent data that has to be synchronized. Moreover, designated interface for communicating with storage controllers are not required.

Optionally, the access data documents write operations. The number of write operations may be estimated according to a number of LAYOUTCOMMIT messages and/or a delay between the reclaiming interval and the interval at which a respective response is sent. Optionally, write operations associated with the pending layout requests may be identified according to messages indicative of write operations.

Optionally, the access data documents additional access data by analyzing LAYOUTGET fields, for example OFFSET and MINLENGTH. This additional data may be used to detect sequential and append access operations to files.

Optionally, the rate at which each layout is reclaimed is determined according to an indicator, such as a flag, that marks an estimated data access frequency, an importance of the data segments mapped by the layout, and/or any other criterion selected by an operator and/or set automatically.

Optionally, the data objects which are reclaimed for acquiring access data are sub files. The size of the sub files is optionally dynamically adapted according to an indicator, such as a flag, that marks an estimated data access frequency, an importance of the data segments mapped by the layout, and/or any other criterion selected by an operator and/or set automatically.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java,

Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

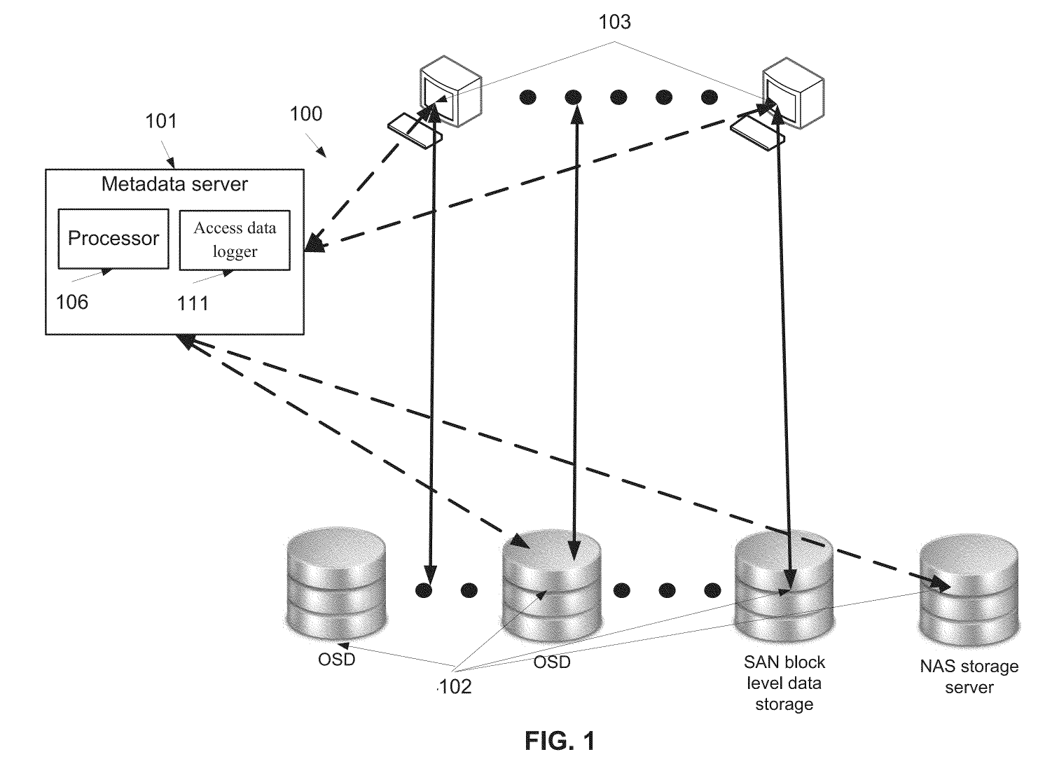

Reference is now made to FIG. 1, which is a schematic illustration of a storage system 100, optionally a concurrent retrieval configuration system 100, such as a pNFS storage system, that includes metadata server (MDS) 101 and a plurality of storage devices (also known in pNFS as data servers) 102 which provide storage services to a plurality of concurrent retrieval clients 103, according to some embodiments of the present invention. Optionally, the metadata server 101 logs data indicative of access operations, such as read and/or write operations, in the storage devices 102, for example according to a protocol such as pNFS protocol.

Optionally, the metadata server 101 and one or more of the storage devices 102, for example storage servers, are hosted on a common host. According to some embodiments of the present invention, a number of metadata servers 101 are used. In such an embodiment, the metadata servers 101 are coordinated, for example using a node coordination protocol. For brevity, a number of metadata servers 101 are referred to herein as a metadata server 101.

A client 103, which is optionally a pNFS client 103 capable of communicating according to pNFS protocol, may be, for example, a conventional personal computer (PC), a server-class computer, a laptop, a tablet, a workstation, a handheld computing or communication device, a hypervisor and/or the like. A storage device 102 is optionally an object storage device (OSD), for example a server, such as a file-level server, for example, a file-level server used in network attached storage (NAS) environment or a block-level storage server such as a server used in a storage area network (SAN) environment. The storage device 102 can include, for example, conventional magnetic or optical disks or tape drives; alternatively, they can include non-volatile solid-state memory, such as flash memory, or be a gateway to storage available on a cloud, such as Amazon S3 and/or the like.

Optionally, the metadata server 101 runs an access data logger 111 that monitors access data of data segments of data stored in each one of the storage devices 102. The access data is optionally acquired, as described below, by periodically reclaiming, also referred to as recalling, data designated by accepted layout requests. The access data logger 111 allows statically analyzing the access data to detect usage patterns, for example file and/or sub file usage patterns. It should be noted that the term file which is used herein describes any data object, such as a file, a subfile, and/or the like. It should be noted that the access data logger 111 and/or a repository which is used to store access data may be stored in the metadata server 101 and/or be external to the metadata server 101.

This may allow managing the storage on the storage devices 102 in real time, namely while the parallel access network file system 100 provides service to the client, also referred to as operation period, according to real time access data, for example actual usage patterns. In some embodiments the storage devices 102 comprise a tiered storage that includes different types of storage media. As an example, the tiered storage includes tier 1 data storage that is a relatively expensive and high-quality media such as Solid-state drive (SSD) based, tier 2 data storage that is a less expensive media, such as SAS drives based, and tier 3 data storage that is a relatively inexpensive storage such as SATA drives based. In such embodiments, the tier of the storage in which data segments of data are stored is correlative to the data's access and/or usage rate. In some embodiments caching and/or other decision based data storage allocation. (e.g. candidates for compression) in the storage devices 102 is made according to the access data.

In use, the storage system 100 handles data control requests, for example layout requests, recall requests, layout return requests and the plurality of storage devices 102 process data access requests, for example data writing and retrieving requests.

Optionally, the metadata server 101 includes one or more processors 106, referred to herein as a processor, memory, communication device(s) (e.g., network interfaces, storage interfaces), and interconnect unit(s) (e.g., buses, peripherals), etc. The processor 106 may include central processing unit(s) (CPUs) and control the operation of the system 100. In certain embodiments, the processor 106 accomplishes this by executing software or firmware stored in the memory. The processor 106 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

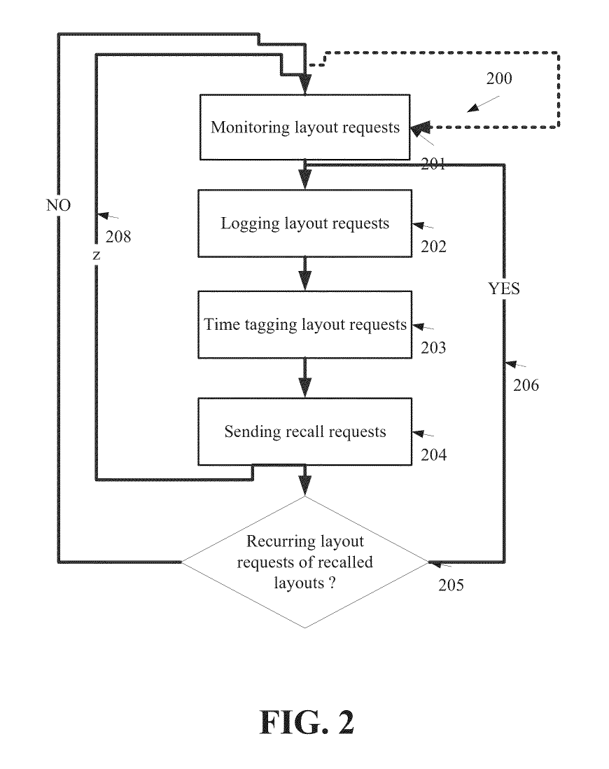

Reference is now also made to FIG. 2, which is a flowchart of a method 200 for gathering access data of files stored in storage devices of a parallel access network file system, such as the system depicted in FIG. 1, according to some embodiments of the present invention.

In use, as shown at 201, the access data logger 111 monitors a plurality of layout requests which are received from the clients 103. For example, the pNFS operation for requesting a layout is LAYOUTGET. Each layout request is for a layout, such as a pNFS layout, which maps the data of a file, such as an NFS file, (or portion of a file) to data segments of storage volumes that contain the file. Optionally, data segments are expressed as extents with 64-bit offsets and lengths using the existing NFSv4 offset4 and length4 types.

As shown at 202, each layout request is logged, for example a record indicative of a client that has submitted the layout request and the requested layout. Optionally, as shown at 203, the layout requests are time tagged. Optionally, a usage counter is updated in a dataset documenting the data segments and/or files. Optionally, the time tagging is made per layout, for example as described below. Optionally, the time tagging is made periodically to some or all of the layouts, optionally simultaneously, for example to all clients using a certain file or subfile, or to all layouts granted in an aligned time slot of X seconds.

As shown at 204, a plurality of recall requests are sent to the clients 103 to reclaim the layout that has been allocated in response to the logged layout requests, for example based on usage counters. The recall requests are optionally CB_LAYOUTRECALL requests. As shown at 208, monitoring is continuously performed after the recall requests are sent.

Optionally, each recall request is timed according to the respective time tags of the logged layout requests. For example, a recall request is sent after a waiting period of about 1 minute, 10 minutes (min), 30 min, 60 min, 90 min, 24 hours, or any intermediate or longer period. By using shorter periods the accuracy of conclusions made based on logged access data are increased; however, induces the dissemination of more layout requests and thus degrade the performance of the system 100.

Optionally, the waiting period is selected according to one or more properties of the layout requests, the layouts, and/or storage devices which are used for storing the requested layouts. In such a manner, the level of granularity of recalling a layout may depend on the target storage tier. Optionally, layouts are reclaimed more often if the file is considered for a higher (better) storage tier. In such a manner, the average number of meta-data operations in both clients 103 and metadata server 101 is reduced to assist in preserving pNFS performance.

As shown at 205, recurring layout requests, which are captured a certain period after the recall requests have been sent, are captured. These are captured, for example as shown at 206, the access data is updated according to the recurring layout requests, for example by logging the recurring layout requests or indications thereof, for instance by updating a usage counter. The monitoring continues when no recurring layout requests are captured. Optionally, the above time tags are reset. A layout request, sent from a client a certain period after the reclaim request has been sent, is indicative that the requested layout is still in use by the client. In such a manner, by periodically reclaiming outstanding layouts the access data logger 111 may deduce which of the layouts are actually still in use. If a layout is still being used, at least one pNFS client issues a recurring layout request after it is reclaimed.

During and/or after the monitoring and logging process described above, the logged access data may be analyzed to determine access and/or usage patterns of data segments of files. This analysis may be used for automatic tiering, caching, and/or other decision based data storage allocation. (e.g. candidates for compression) of data segments. For example, in automatic tiering, data segments may be migrated in real time between storage devices of different tiers according to up-to-date empiric data which is indicative of their usage.

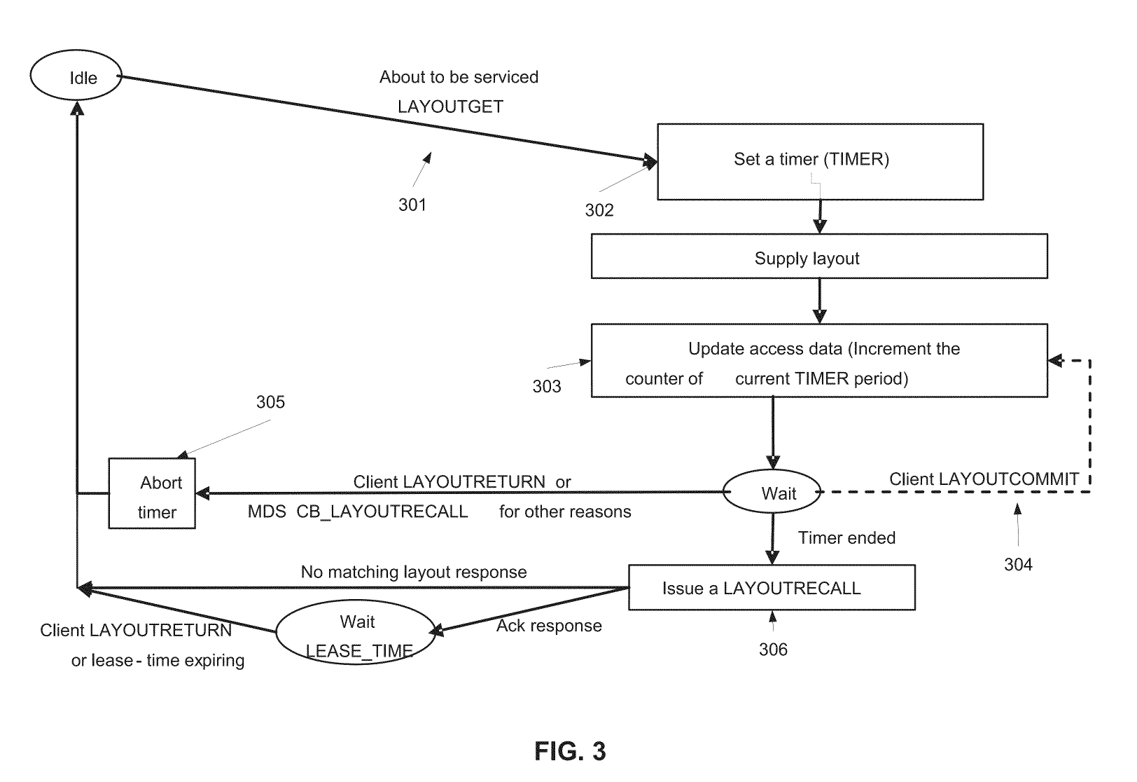

For example, reference is now made to FIG. 3, which is a schematic illustration of a state machine wherein states reflect actions and transition arrows relate to external triggers which are performed with regard to a certain file or a subfile, according to some embodiments of the present invention.

As shown at 301, upon serving a pNFS client LAYOUTGET request with the certain layout, the metadata server also optionally sets a timer 302 in order to reclaim this certain layout when the timer expires and updates a usage counter 303. Optionally, as shown at 304, if the client 103 issues a LAYOUTCOMMIT message, for example when a client wants to make sure that that the metadata is updated within the MDS 101, for example file modification time and/or size. Optionally, as shown at 305, if the client 103 explicitly releases the certain layout for example by issuing a LAYOUTRETURN message, or if the metadata server calls the certain layout from any other reason, for example using a MDS CB_LAYOUTRECALL message, the timer is aborted. For example, the metadata server may decide that it cannot hold all of the states for layouts without running out of resources and recall individual layouts using CB_LAYOUTRECALL to reduce the load.

As shown at 306, when the waiting time for the certain layout elapsed, a recall message is sent to the client for reclaiming the certain layout, for example by issuing a LAYOUTRECALL message. The client 103 may response to the reclaim call by sending a LAYOUTRETURN or by letting lease-time, which is indicative of a time during which layouts are valid (from when the server granted them), to expire without renewal. Optionally, a client may send a LAYOUTRETURN that covers a smaller byte range than installation set. This may be viewed by the MDS as progress made by the client and lead to extending said wait time.

The process depicted in FIG. 3 may be repeated iteratively for each one of the requested layouts.

According to some embodiments of the present invention, the time elapsed between sending of a recall request for a layout to a client and the reception of a message indicative of a writing operation. The message may be a LAYOUTCOMMIT—a message sent in order to synchronize file system metadata state between MDS and the storage devices. In this context, LAYOUTCOMMIT is used by the client to receive an acknowledgment for a writing operation.

As in FIG. 3 when LAYOUTRETURN message is detected the timer is aborted. This massage that represents an explicit release of resources by the client. It should be noted that the client may return disjoint regions of the file by using multiple LAYOUTRETURN operations within a single COMPOUND operation.

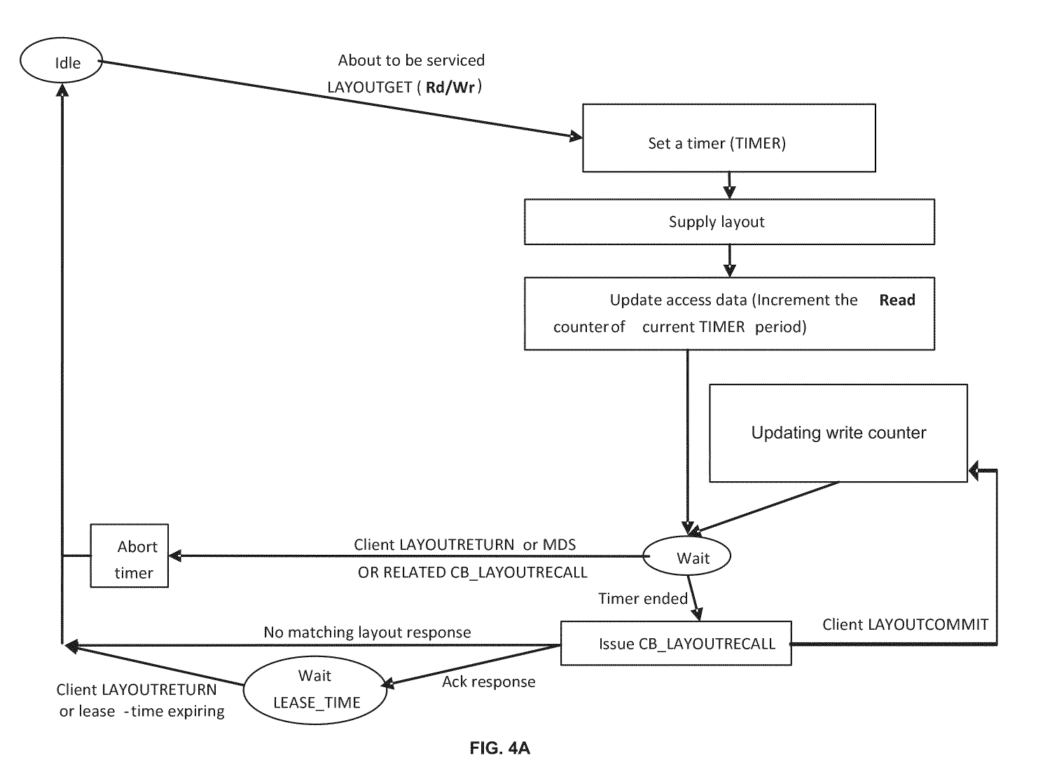

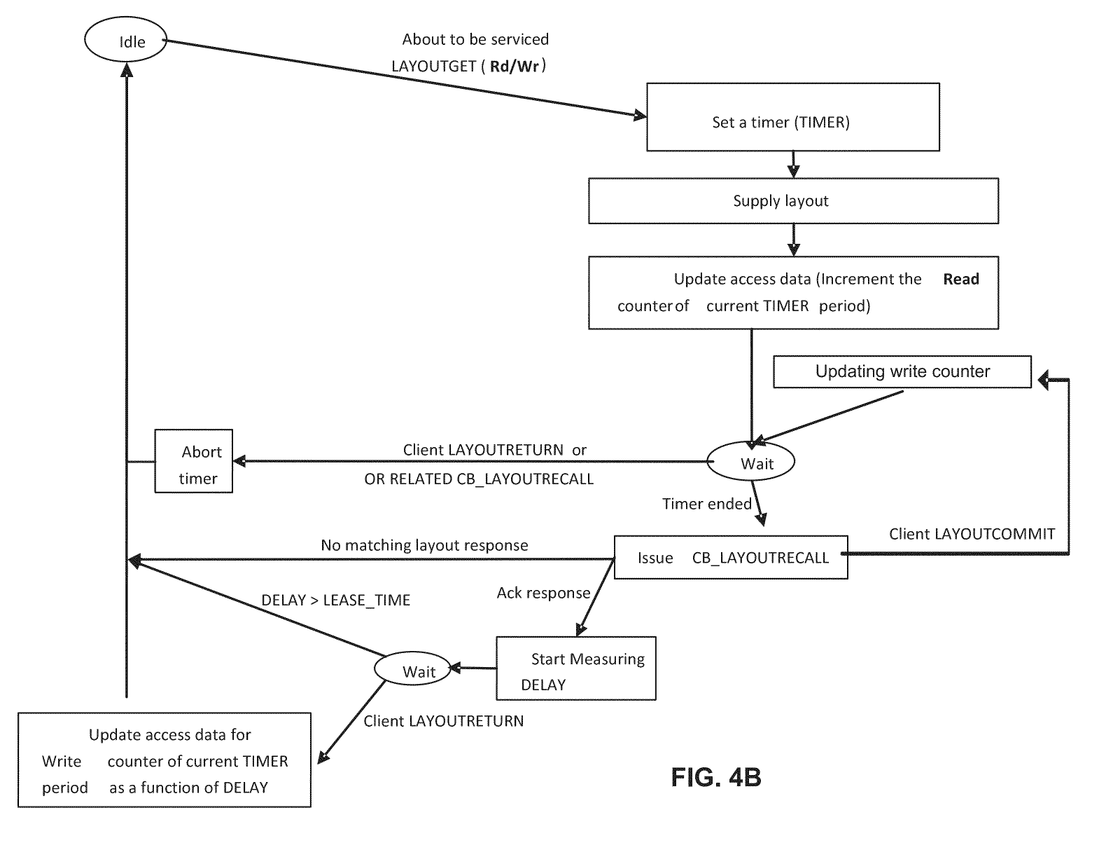

For example FIG. 4A depicts a schematic illustration of a state machine that is similar to the state machine in FIG. 3; however in this state machine a write counter is updated when a write operation is detected, optionally as a function of a delay, according to some embodiments of the present invention.

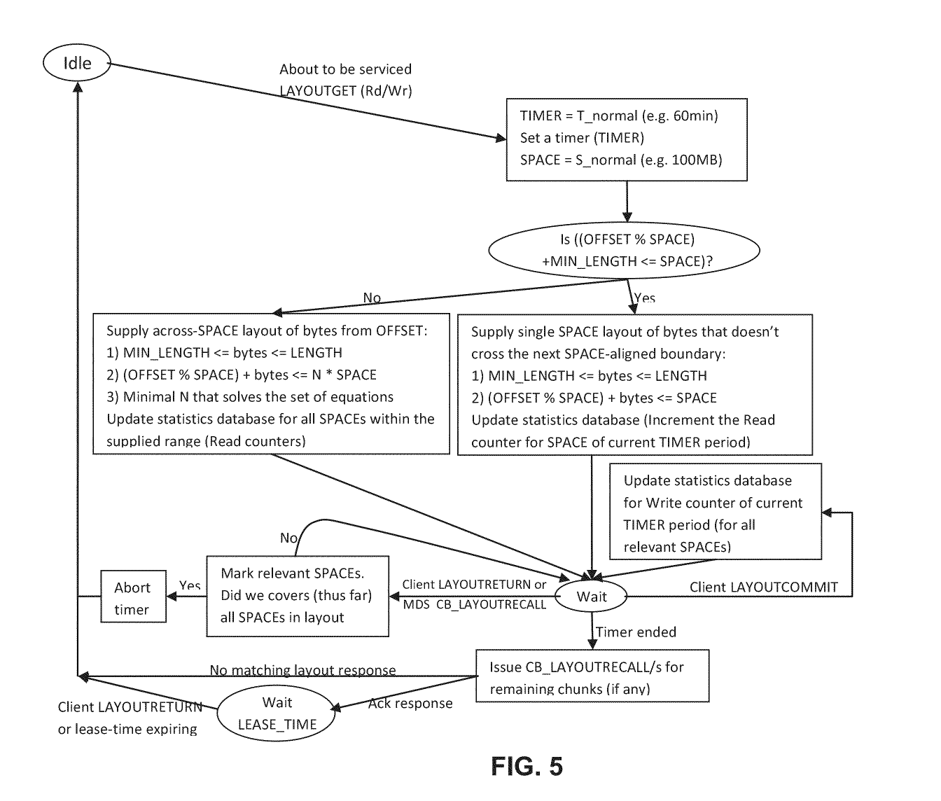

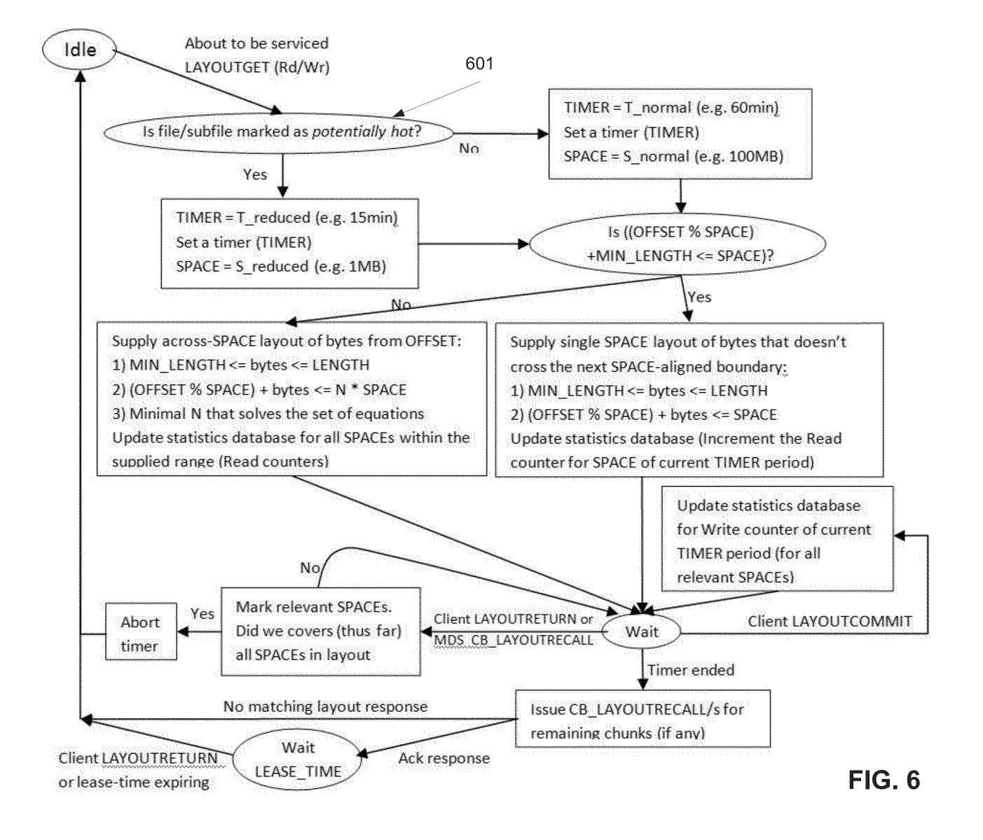

In the simplest form, a write counter in a database, referred to herein as a statistics database, may be updated if the LAYOUTGET carries a write flag and/or for LAYOUTCOMMIT messages and/or if the MDS sent a LAYOUTRECALL request—if the LAYOUTRETURN is not received for more than a certain threshold. In another embodiment, a linear dependence (y=Ax+B) is assumed so that write_counter_increment=A*measured_DELAY+B, in which A and B may be constant averages and/or even semi-constant averages that are a function of the workloads, pNFS, client, data server, time (i.e. hour and/or day), and/or network load. This is illustrated in the FIG. 4B. It should be note that the write counter updating may be performed in a similar manner to the depicted in FIG. 4B (instead of the method depicted in FIG. 4A) in any of the state machines depicted in FIGS. 5 and 6.

According to some embodiments of the present invention, access data is gathered about a certain byte range of a file or a subfile, namely access data pertaining to a subfile segment and not about a layout for a certain file as a whole. The access data may be indicative of write and/or read access. The size of the subfile segments may be defined in advance, for example 1 KB, LOMB, 100 MB, 1 GB, or any intermediated or larger size. In its simplest form, the size of the subfile segments can match the pNFS striping or RAID size, or be aligned to it. For example, FIG. 5 is a schematic illustration of a state machine, which is similar to the state machine of FIG. 3; however in this state machine a counter is updated for each file chuck (defined by a SPACE variable—indicating size), according to some embodiments of the present invention. As depicted in FIG. 5 the control flow adds complexity due to the need to update several entries in the database (one per SPACE range). It should be noted that the layout range may be set by other boundaries setting mechanism.

According to some embodiments of the present invention, the rate at which a subfile segment is reclaimed is adapted dynamically according to the ranking thereof. For example, each file or subfile may be marked with an access rate indicator, such as a flag or a numerator, which implies in which granularity statistical data pertaining to access is desired, for example in temporal and/or spatial granularity. For example, FIG. 6 depicts a state machine that uses such a flag for setting a higher reclaiming rate for files and/or subfiles which are ranked as potentially hot 601. The access rate indicator may be user defined, policy defined, and/or automatic. For example, one or more ranking and/or flagging processes which invoke periodically, randomly and/or manually, reviews access data, for example access data that is gathered as described above, and marks the most used files and/or subfiles as hot and unmarks less used files and/or subfiles. In one embodiment, the process may use the following criteria for decision:

Mark subfile or file as hot (i.e. for solid-state drive (SSD)) iff (Sigma (over last 48 hours) Read_counter)>a high threshold;

Unmark subfile or file (back to cold) (i.e. for lower tier) iff (Sigma (over last month) Max (Read_counter, Write_counter)<a low threshold;

According to some embodiments of the present invention, some of the clients gather in-band access rate data, for example average read/write operations. These in band data may be used for compensating the data collected in an MDS out-of-band method, for example the above described methods, for example, Read_counter+=Reads_per_layout_get_average may be used instead of Read_counter++). Such a process may be used in mixed environments in which in-band statistics is gathered for some of the clients, for example pNFS clients. In these environments, the MDS 101 may collect out-of-band statistics, as described above, only for the other clients.

According to some embodiments of the present invention, sequential accesses which last for more than a certain period, for example access to movie files is identified and logged. For example, when a layout is supplied according to an OFFSET field of a LAYOUTGET request, a timestamp is kept and compared with a timestamp of a preceding subfile (preceding subfile within file). If a group of sequential subfiles were sequentially accessed within a certain period, for example several seconds, a sequential access counter is incremented indicating that a sequential access pattern is detected. Now sequentially accessed files may be identified as files or subfiles having similar values for read/write subfiles and sequential access counters. This allows automatic tiering of the log file according to sequential file handling strategy, for example not stored in a storage device with good random IO performance (SSD).

Optionally, files are adaptively allocated (optionally including reallocated) to storage devices which are designated for sequential access. This adaptive allocation may be performed in a similar manner to the adaptive process depicted in FIG. 6. For example, smaller SPACEs are set for sequential access files.

According to some embodiments of the present invention, write append access to files is identified by analyzing the LAYOUTGET request content. If the OFFSET of LAYOUTGET requests for write operations in a certain file sequentially address the last memory section of the certain file, for example the last bytes of the file, than the file may be classified as a log file. This allows automatic tiering of the log file according to log file handling strategy, for example stored in a storage device with a low tier ranking.

According to some embodiments of the present invention, a ratio between write operations and read operations of a file are identified by analyzing the LAYOUTGET requests content. This allows allocating subfiles which are rarely written to in sensitive storage devices such as SSDs without substantial wear.

According to some embodiments of the present invention, one or more MINLENGTH values are acquired from the respective field(s) in one or more of the LAYOUTGET requests. Small MINLENGTH values may indicate random I/O of a certain client. This allows automatic tiering, caching, and/or other decision based data storage allocation. (e.g. candidates for compression of the respective file or subfile.

The MINLENGTH values may be used to identify performance-critical files that should be cached and/or migrated to other storage devices with different tiering. For example, during every LAYOUTGET operation, an inverse bitmap b may be calculated as follows:

b=2^{C-└log2(N)┘}

Where C denotes an implementation constant and N denotes a value representing an estimated number of pages read/written from a file, i.e. MINLENGTH/page size. The computed value is then added to a counter associated with that file or subfile. Thus, the exemplified inverse bitmap function assigns a large weight to files assumed to read/written small subfiles, thereby prioritizing random accesses over sequential ones. For the in-band equivalent of this function, in which N can be computed rather than estimated per read and write operation, see Raja Appuswamy, Integrating Flash-based SSDs into the Storage Stack, Vrije Universiteit, Amsterdam, Apr. 19, 2012.

According to some embodiments of the present invention, the access data is analyzed to identify input/output (I/O) intensiveness in storage devices. Whenever a recall request, such as a CB_LAYOUTRECALL, is sent, the metadata server 101 measures the time it takes the client (e.g. from LAYOUTRETURN) to re-request the layout, for example the amount of bytes of former offset). If the time is shorter than a certain threshold, the database is updated accordingly. As CB_LAYOUTRECALL is sent at arbitrary times from an application side, the identification of a high re-requests rate, for example above a certain threshold, including a high access rate and/or a high access time-locality is indicative of a high I/O intensiveness.

Such I/O intensiveness events may be marked explicitly (e.g. new statistics field) or implicitly (e.g. increment the IO counter by 10 rather than by 1). Optionally, smaller SPACEs and TIMER units are set to get better statistics of application behavior.

Note that this information may be gathered for the same pNFS client (returning and immediately re-requesting), or per different pNFS clients (one returns the layout and another one issues a new layout get, which may imply highly-shared data or a virtual machine that was moved to another physical host).

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the term a storage device, a server, a metadata server, and a database is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for gathering access data of a file stored in one or more storage devices of a parallel access network file system, comprising:
monitoring a plurality of layout requests received from a plurality of clients of said parallel access network file system, each said layout request is for a layout of data segments of one of a plurality of data objects which are stored in a plurality of storage devices of a parallel access network file system;
sending to said plurality of clients a plurality of recall requests to recall a plurality of layouts requested by said plurality of layout requests;
monitoring a plurality of recurring layout requests for mapping data segments of at least some of said plurality of data objects from at least some of said plurality of clients; and
updating access data of said plurality of data objects according to said plurality of recurring layout requests.

2. The computerized method of claim 1, wherein each said recall request is iteratively sent for reclaiming a respective said layout in a dynamic rate that is set for said respective layout.

3. The computerized method of claim 2, wherein said dynamic rate is set according to a tier of at least one of a storage device which hosts data segments mapped by said layout and an access data ranking of data segments mapped by said layout.

4. The computerized method of claim 1, further comprising updating said access data to indicate which of said plurality of layout requests is sent for a write operation and accordingly.

5. The computerized method of claim 4, wherein said updating comprises detecting a message indicative of a writing operation that is performed by a respective said client.

6. The computerized method of claim 4, wherein said updating comprises measuring a time period between the sending of each said recall request and a detection of a message indicative of the release of a respective layout.

7. The computerized method of claim 1, further comprising time tagging each said layout request; wherein said sending comprises timing the sending of each said recall request according to a time tag of a respective said layout request.

8. The computerized method of claim 7, further comprises ranking said plurality of data objects; wherein said timing comprises timing the sending of each said recall request according to the rank of a respective data object which is mapped by said respective said layout request.

9. The computerized method of claim 1, wherein said sending is performed iteratively every predefined period.

10. The computerized method of claim 9, wherein said plurality of layout requests and said plurality of recurring layout requests are LAYOUTGET requests.

11. The computerized method of claim 1, wherein said parallel access network file system is a parallel network file system (pNFS).

12. The method of claim 1, wherein said monitoring is performed during an operation period of said parallel access network file system; further comprising reallocating data segments of at least some of said plurality of data objects according to said access data during said operation period.

13. The method of claim 12, wherein said plurality of storage devices are tiered to a plurality of tiers, further comprising performing said reallocating according to said access data to correlate between access frequency of said data segments and the tier of a respective said storage device.

14. The computerized method of claim 1, wherein said plurality of data objects comprise a plurality of subfiles of a plurality of files.

15. The computerized method of claim 14, further comprising setting an access rate indicator to each said subfile; wherein each said recall request is iteratively sent for reclaiming a respective said layout in a rate that is adaptively determined based on a respective said access rate indicator.

16. The computerized method of claim 13, further comprising dividing said plurality of files to said plurality of subfiles; wherein the size of at least some of said plurality of subfiles is set according to a respective access rate indicator.

17. The computerized method of claim 1, further comprising measuring a time period between the sending of each said recall request and a detection of a respective recurring layout request from said plurality of recurring layout requests and estimating a write related input/output (I/O) intensiveness of a respective said client.

18. The computerized method of claim 1, further comprising analyzing an OFFSET field in at least some of said plurality of recurring layout requests and said plurality of layout requests to identify in a sequential access to the last section of at least one of said plurality of data segment, and reallocating said at least one segment in response to said identification.

19. The computerized method of claim 1, further comprising analyzing at least some of said plurality of recurring layout requests and said plurality of layout requests to identify in a sequence of write append access to the last section of at least one of said plurality of data segment, and reallocating said at least one data segment in response to said identification.

20. The computerized method of claim 11, further comprising acquiring MINLENGTH values of at least some of said plurality of recurring layout requests and updating said access data accordingly.

21. A metadata server of a parallel access network file system, comprising:
a processor;
a database;
a monitoring module which monitors a plurality of layout requests each for mapping data segments of one of a plurality of data objects which are stored in a plurality of storage devices of a parallel access network file system, said plurality of layout requests being received from a plurality of clients of said parallel access network file system;
an access data logger; which updates access data stored in said database according to said plurality of layout requests; and
a recall module which sends a plurality of recall requests to said plurality of clients according to said plurality of layout requests;
wherein said monitoring module monitors a plurality of recurring layout requests for mapping data segments of at least some of said plurality of data objects from at least some of said plurality of clients:
wherein said access data logger updates said access data according to said plurality of recurring layout requests.

22. The metadata server of claim 21, wherein said metadata server is a metadata server of a parallel network file system (pNFS).

23. A computer program product for gathering access data of a data object stored in one or more storage devices of a parallel access network file system, comprising:
a computer readable storage medium;
first program instructions to monitor a plurality of layout requests each for mapping data segments of one of a plurality of data objects which are stored in a plurality of storage devices of a parallel access network file system, said plurality of layout requests being received from a plurality of clients of said parallel access network file system;
second program instructions to send a plurality of recall requests to said plurality of clients according to said plurality of layout requests;
third program instructions to monitor a plurality of recurring layout requests for mapping data segments of at least some of said plurality of data objects from at least some of said plurality of clients: and
fourth program instructions to update access data of said plurality of data objects according to said plurality of recurring layout requests;
wherein said first, second, third, and forth program instructions are stored on said computer readable storage medium.
